(19) United States
(12) Patent Application Publication
(10) Pub. No.: US 2018/0237295 A1
(43) Pub. Date: Aug. 23, 2018

(54) ELECTRIC WIRE OF CARBON NANOTUBE TWISTED YARN AND METHOD FOR PRODUCING THE SAME

(71) Applicant: Yazaki Corporation, Tokyo (JP)

(72) Inventor: Tetsuharu KUMAGAI, Susono-shi (JP)

(73) Assignee: Yazaki Corporation, Tokyo (JP)

(21) Appl. No.: 15/896,631

(22) Filed: Feb. 14, 2018

(30) Foreign Application Priority Data
Feb. 17, 2017 (JP) 2017-027819

(51) Int. Cl. B82Y 40/00; B82Y 30/00; C01B 32/168; C01B 32/16

(52) U.S. Cl. CPC B82Y 40/00; B82Y 30/00; D02G 3/36; C01B 32/16; C01B 32/168

(57) ABSTRACT

A method for producing an electric wire of a carbon nanotube twisted yarn is provided. The method includes obtaining a carbon nanotube twisted yarn by a dry spinning method, subjecting the carbon nanotube twisted yarn to a graphitization treatment, imparting an oxygen-containing functional group to the graphitized carbon nanotube twisted yarn, and imparting an electron-attracting group having a stronger electron-attracting property than the oxygen-containing functional group to the carbon nanotube twisted yarn to which the oxygen-containing functional group has been imparted. With such a configuration, an electric wire of a carbon nanotube twisted yarn having high conductivity can be produced.

### CROSS-REFERENCE TO RELATED APPLICATIONS

This application is based upon and claims the benefit of priority from the prior Japanese Patent Application No. 2017-027819, filed on Feb. 17, 2017, the entire contents of which are incorporated herein by reference.

### BACKGROUND OF THE INVENTION

### 1. Field of the Invention

The present invention relates to an electric wire of a carbon nanotube twisted yarn and a method for producing the same. More specifically, the present invention relates to an electric wire of a carbon nanotube twisted yarn produced by a dry spinning method and a method for producing the same.

### 2. Description of the Related Art

Carbon nanotubes (hereinafter also referred to as “CNTs”) are lightweight and have conductivity, and are thus expected to be used as lightweight conductive materials. In particular, carbon nanotube twisted yarns (CNT twisted yarn) obtained by twisting spun CNT is expected to be utilized as conductive wires.

As a conductive wire using a CNT twisted yarn, for example, JP 4577385 proposes a conductive wire constituted by a plurality of CNTs and a conductive wire constituted by a fibrous aggregate of boron-nitrogen-containing fine fibers obtained by substituting at least a part of carbons constituting CNTs with boron, and a method for producing the same. In addition, JP 2011-26192 A proposes a method of producing a twisted CNT wire by twisting a CNT film drawn out from a CNT array. Furthermore, JP 2011-207646 A proposes a method of obtaining a CNT twisted yarn by preparing a CNT aggregate formed by chemical vapor deposition on a substrate, and obtaining the CNT twisted yarn using this CNT aggregate.

However, the CNT twisted yarns and the like described in JP 4577385, JP 2011-26192 A, and JP 2011-207646 A are not intended to improve conductivity. Therefore, the conductivity of the CNT twisted yarns and the like does not go beyond the range of conductivity inherent in CNT.

A CNT twisted yarn is produced by a method such as a wet spinning method or a dry spinning method. The wet spinning method is a spinning method of high cost because the wet spinning method requires a large amount of chemicals in various steps. In contrast, the dry spinning method is a simple spinning method of low cost because spinning is performed directly from a CNT substrate in the dry spinning method. However, it is difficult to produce a CNT twisted yarn with a high conductivity by a dry spinning method. Therefore, attempts have been made to improve conductivity of a CNT twisted yarn obtained by a dry spinning method.

JP 2014-169521 A describes a CNT fiber in which a large number of CNTs are compressed in the radial direction and gathered at a high density without forming gaps therebetween. This structure is made to improve the electrical conductivity as well as a mechanical property.

In addition, JP 5699387 discloses a CNT twisted yarn obtained by laminating a plurality of CNT sheets to reduce unevenness of, for example, orientations of, thicknesses of, and gaps between CNT bundles, gathering the CNT bundles into one bundle, and then twisting and stretching the one bundle. For this CNT twisted yarn, it is attempted to improve the conductivity and mechanical properties of the CNT twisted yarn by improving the linearity and parallelism of the CNT bundle.

### BRIEF SUMMARY OF THE INVENTION

However, although some improvement in conductivity can be anticipated from the CNT twisted yarns described in JP 2014-169521 A and JP 5699387, the improvement is not sufficient.

The present invention has been made in view of such problems of conventional techniques. An object of the present invention is to provide an electric wire of a carbon nanotube twisted yarn having high conductivity and a method by which an electric wire of a carbon nanotube twisted yarn having high conductivity can be produced by a dry spinning method.

A method for producing an electric wire of a carbon nanotube twisted yarn according to a first aspect of the present invention includes obtaining a carbon nanotube twisted yarn by a dry spinning method, subjecting the carbon nanotube twisted yarn to a graphitization treatment, imparting an oxygen-containing functional group to the graphitized carbon nanotube twisted yarn, and imparting an electron-attracting group having a stronger electron-attracting property than the oxygen-containing functional group to the carbon nanotube twisted yarn to which the oxygen-containing functional group has been imparted.

A method for producing an electric wire of a carbon nanotube twisted yarn according to a second aspect of the present invention relates to the method for producing an electric wire of a carbon nanotube twisted yarn according to the first aspect, and further includes doping the carbon nanotube twisted yarn to which the electron-attracting group has been imparted with one or a plurality of dopants.

A method for producing an electric wire of a carbon nanotube twisted yarn according to a third aspect of the present invention relates to the method for producing an electric wire of a carbon nanotube twisted yarn according to the first aspect, wherein the one or plurality of dopants are at least one selected from a group consisting of halogens, halogen compounds, alkali metals, group 2 elements, acids, and electron-accepting organic compounds.

An electric wire of a carbon nanotube twisted yarn according to a fourth aspect of the present invention includes a carbon nanotube twisted yarn coated with an insulating resin, wherein a peak ratio (G/D) of a G band and a D band in a Raman spectrum of the carbon nanotube twisted yarn is 8 or larger, and an electron-attracting group is imparted to a surface of the carbon nanotube twisted yarn.

An electric wire of a carbon nanotube twisted yarn according to a fifth aspect of the present invention relates to the electric wire of a carbon nanotube twisted yarn according to the fourth aspect, and further includes a dopant on the surface thereof.

According to an aspect of the present invention, an electric wire of a carbon nanotube twisted yarn having high conductivity and a method by which an electric wire of a carbon nanotube twisted yarn having high conductivity can be produced by a dry spinning method can be provided.

### BRIEF DESCRIPTION OF DRAWINGS

FIG. 1A is a top view of a schematic diagram showing how a carbon nanotube twisted yarn is spun by a dry spinning method;

FIG. 1B is a side view of a schematic diagram showing how a carbon nanotube twisted yarn is spun by a dry spinning method;

FIG. 2 is a diagram showing Raman spectra before and after a graphitization treatment of carbon nanotube;

FIG. 3 is a diagram for describing measurement of the resistance value of a CNT twisted yarn by a four-terminal method;

FIG. 4 is a cross-sectional view schematically showing an example of an electric wire of a CNT twisted yarn in which a plurality of CNT twisted yarns are twisted together and coated with an insulating resin;

FIG. 5 is an electron micrograph showing a carbon nanotube twisted yarn having undergone a doping treatment;

FIG. 6 is an electron micrograph showing element mapping obtained by EDS analysis of the composition of a part of the surface of a carbon nanotube twisted yarn;

FIG. 7 is a diagram showing Raman spectra of iodine adhering to a carbon nanotube twisted yarn as a dopant; and

FIG. 8 is a diagram showing the relationship between the peak intensity ratio of I₅⁻ peak to a G peak of a Raman spectrum and conductivity.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

Hereinafter, an electric wire of a carbon nanotube twisted yarn according to an embodiment of the present invention and a method for producing the same will be described in detail with reference to the drawings. To be noted, the dimensional ratios in the drawings are exaggerated for convenience of explanation and may differ from the actual ratios.

Method for Producing Electric Wire of CNT Twisted Yarn

A method for producing an electric wire of a CNT twisted yarn according to the present embodiment includes a step of obtaining a CNT twisted yarn by a dry spinning method (hereinafter also referred to as “step A”), a step of subjecting the CNT twisted yarn to a graphitization treatment (hereinafter also referred to as “step B”), a step of imparting an oxygen-containing functional group to the graphitized CNT twisted yarn (hereinafter also referred to as “step C”), and a step of imparting an electron-attracting group having a stronger electron-attracting property than the oxygen-containing functional group to the carbon nanotube twisted yarn to which the oxygen-containing functional group has been imparted (hereinafter also referred to as “step D”). Each step will be described below.

Step A

Step A is a step of obtaining a CNT twisted yarn by a dry spinning method. In this step, any method may be used as long as the method is a dry spinning method in which CNTs are continuously drawn from a CNT forest grown in an oriented manner.

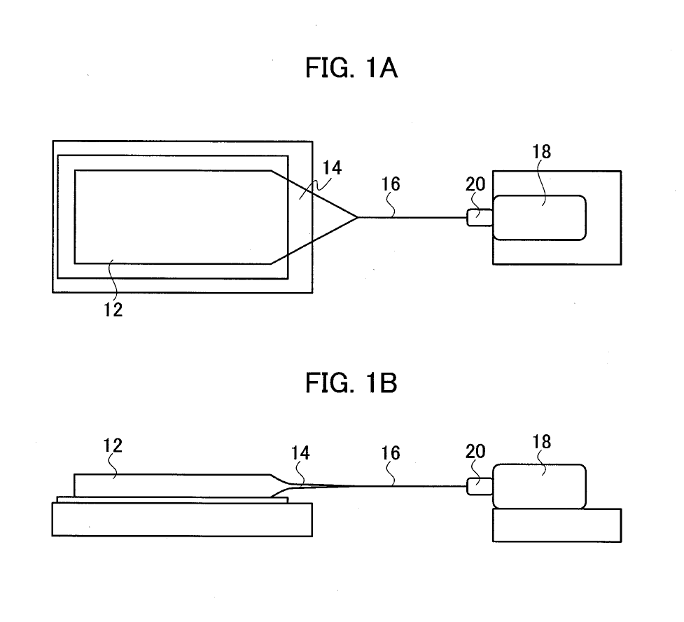

An example of this step will be described with reference to FIG. 1A and FIG. 1B. A configuration shown in FIG. 1 and FIG. 1B. include a CNT forest 12 vertically grown on a metal substrate by a chemical vapor deposition (CVD) method, a chuck 20, and a motor 18 directly including a rotation shaft to which the chuck 20 is directly connected. In this configuration, when spinning a CNT twisted yarn, a plurality of CNT sheets 14 are continuously drawn from an end portion of the CNT forest 12 in the form of sheets, and the motor 18 is rotated after connecting the CNT sheets 14 to the chuck 20. The CNT sheets 14 are twisted by the rotation of the motor 18, and thus a CNT twisted yarn 16 is obtained.

As the CNT, in addition to multi-walled carbon nanotube (MWCNT), double-walled carbon nanotube (DWCNT) or single-walled carbon nanotube (SWCNT) may be used. In addition, the CNT forest 12 has a bulk density of 10 mg/cm³ or higher and 60 mg/cm³ or lower, and preferably of 20 mg/cm³ or higher and 50 mg/cm³ or lower. The bulk density of the CNT forest 12 is calculated, for example, from the mass per unit area (basis weight (mg/cm²)) and the average length of CNTs. The average length of CNTs is 1 μm or larger and 1000 μm or smaller, and preferably 100 μm or larger and 500 μm or smaller. The average outer diameter of the CNTs is 1 nm or larger and 100 nm or smaller, and preferably 50 nm or smaller. To be noted, the average length and the average outer diameter of CNTs are measured by a known method such as electron microscope observation.

The twist pitch of the CNT twisted yarn is preferably 0.01 to 2.0 mm, and more preferably 0.05 to 1.0 mm. The diameter of one CNT twisted yarn is preferably 0.5 to 1000 μm, and more preferably 1 to 500 μm.

By the above step A, a CNT twisted yarn having a structure in which CNTs having lengths of 100 μm or larger are twisted together is obtained.

Step B

Step B is a step of subjecting the CNT twisted yarn obtained in step A to a graphitization treatment. In this step, heat treatment is performed in an inert gas in order to improve the crystallinity of the CNT twisted yarn. Then, defects on the surface of CNTs are repaired by heating, and the crystallinity is improved by forming six-membered rings.

The heating temperature for graphitizing is preferably 500 to 3500° C. In addition, the heating time is determined in consideration of the heating temperature, and is preferably 10 minutes to 5 hours. In addition, the rate of temperature rise to 1500° C. is preferably 5 to 30° C./min.

Examples of the inert gas used for setting the inert gas atmosphere during the heat treatment include nitrogen, and noble gases such as helium gas and argon gas.

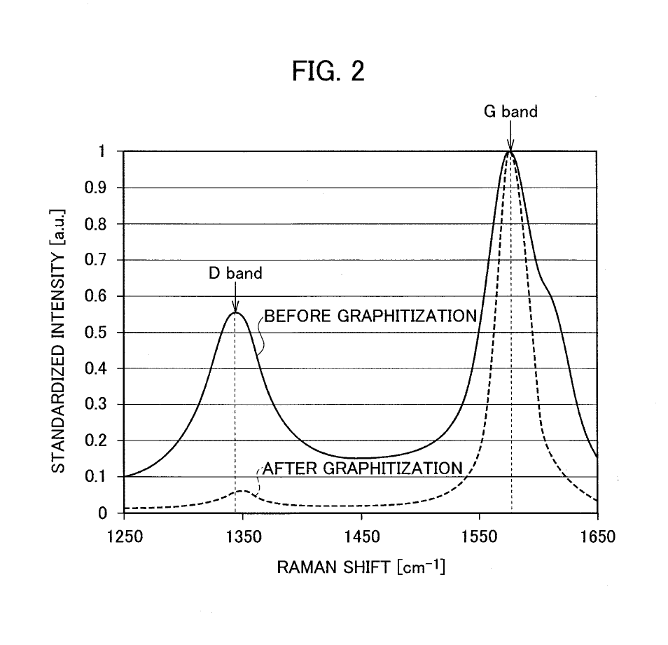

In the CNT twisted yarn, defects on the surface of CNTs is reduced by graphitizing the CNT yarn in this step, and a peak ratio (G/D ratio) between a G band and a D band, which indicates the degree of crystallinity, of a Raman spectrum of the CNT twisted yarn becomes 8 or higher. FIG. 2 shows Raman spectra of the CNT twisted yarn before and after the graphitization treatment, and it can be seen from these spectra that the G/D ratio is improved to 8 or higher after the graphitization treatment compared with before the graphitization treatment. That is, the spectra show that the crystallinity was improved by the graphitization treatment.

Step C

This step is a step of imparting an oxygen-containing functional group to the graphitized CNT twisted yarn. This step is provided for imparting an oxygen-containing functional group to the surface of CNTs to facilitate imparting an electron-attracting group having a stronger electron-attracting property than the oxygen-containing functional group in a subsequent step D. That is, in step D that will be described later, the oxygen-containing functional group is substituted by an electron-attracting group. Here, although the oxygen-containing functional group is included in electron-attracting groups, in this specification, the electron-attracting group of step D is a group having a stronger electron-attracting property than the oxygen-containing functional group of step C.

For imparting the oxygen-containing functional group to the CNT twisted yarn, the CNT twisted yarn may be immersed in an oxidizing agent such as hydrogen peroxide, m-chloroperbenzoic acid, or dimethyl dioxirane. Each of these oxidizing agents may be used alone, or a plurality of oxidizing agents may be used in combination. In addition, the treatment with an oxidizing agent is not necessarily performed once, and may be performed a plurality of times using different oxidizing agents. In addition, in the treatment, it suffices as long as the CNT twisted yarn is held under a liquid surface of a solution containing the oxidizing agent.

The immersion time of the CNT twisted yarn in a solution of, for example, as an oxidizing agent, is preferably 6 to 120 hours in order to sufficiently impart the oxygen-containing functional group.

The oxygen-containing functional group may be imparted by, other than immersion in an oxidizing agent or the like, a plasma irradiation treatment or an ultraviolet light irradiation treatment, for example.

Step D

Step D is a step of imparting an electron-attracting group having a stronger electron-attracting property than the oxygen-containing functional group to the CNT twisted yarn provided to which the oxygen-containing functional group has been imparted. Although the oxygen-containing functional group is also an electron-attracting group, in this step, an electron-attracting group having stronger electron-attracting property than the oxygen-containing functional group is imparted.

For imparting an electron-attracting group to the CNT twisted yarn, the CNT twisted yarn is immersed in, for example, sulfuric acid, nitric acid, permanganic acid, dichromic acid, or chloric acid, whose electron-attracting effect is stronger than the oxidizing agent used in step C. For example, if hydrogen peroxide is used in step C, sulfuric acid is used in this step.

The immersion time of the CNT twisted yarn in a solution of, for example, as an oxidizing agent, is preferably 6 to 120 hours in order to sufficiently impart the electron-attracting group.

As described above, the method for producing the electric wire of the CNT twisted yarn of the present embodiment includes steps A to D, and the conductivity is improved as a result of the crystallinity of the CNT structure being improved by the graphitization treatment in step B, and the electron-attracting group being imparted in steps C and D.

Step E

The method for producing an electric wire of a CNT twisted yarn of the present embodiment preferably further includes step E of doping the CNT twisted yarn to which the electron-attracting group has been imparted with one or a plurality of dopants. Step E will be described below.

Generally, conductivity is proportional to the product of carrier mobility and carrier density. In the present embodiment, the crystallinity of the CNT structure is improved by the graphitization treatment in step B, and thus the carrier mobility is improved. Accordingly, if the carrier density can be increased, the conductivity can be further improved. Therefore, in this step, the conductivity is further improved by improving the carrier density by doping.

The dopant is preferably at least one selected from a group consisting of halogens, halogen compounds, alkali metals, group 2 elements, acids, and electron-accepting organic compounds. Examples of the halogens include fluorine, chlorine, bromine and iodine, and examples of the halogen compounds include MoCl₃, FeCl₃, CuI₃, and FeBr₃ or the like. Examples of the alkali metals include lithium, sodium, potassium, rubidium, and cesium, and examples of the group 2 elements include beryllium, magnesium, calcium, and barium. Examples of the acids include sulfuric acid, nitric acid, Lewis acids such as PF₆, AsF₅, BBr₂, and SO₃. Examples of the electron-accepting organic compounds include 2,3,5,6-tetrafluoro-7,7,8,8-tetracyano-quinodimethane (F4TCNQ), 3,5-dinitrobenzoic acid, tetrakis(dimethylamino)ethylene, tetrathiafulvalene, and tetramethyltetraselenafulvalene, p-toluenesulfonic acid or the like.

As a result of the doping, the dopant permeates through the surface of the CNT twisted yarn to the inside thereof, and is at least attached to the surface of the CNT twisted yarn at the highest concentration. That is, the dopant concentration has a gradient from the edge to the center in the cross section of the CNT twisted yarn. However, the area to which the dopant is attached is not necessarily limited to the vicinity of the surface of the CNT twisted yarn, and there may be a concentration gradient from the surface to the inside, or the vicinity of the surface and the inside may be uniform.

The dopant is not necessarily limited to one type, and two or more dopants may be used at the same time.

Doping can be carried out by a method such as steam exposure method, electrolysis method, vacuum vapor deposition method, solution immersion method, or spray method.

The positions and content of the oxygen-containing functional group and the dopant in the CNT twisted yarn of the present embodiment can be evaluated by elemental analysis by energy dispersive X-ray spectrometry (EDS) or the like while observing a sample by a scanning electron microscope (SEM), a transmission electron microscope (TEM), or the like after processing the sample with an ion milling apparatus or the like. Alternatively, the content of the oxygen-containing functional group in the CNT twisted yarn can be evaluated also by x-ray photoelectron spectroscopy (XPS), and the amount of attached iodine in the CNT twisted yarn can also be evaluated by Raman spectral analysis.

By coating the CNT twisted yarn described above with an insulating resin, the electric wire of the CNT twisted yarn of this embodiment can be obtained. That is, one or a plurality of CNT twisted yarns can be twisted and coated with an insulating resin such as a polymer to obtain an electric wire of a CNT twisted yarn. Further, in order to adjust the diameter and the resistance of the electric wire of the CNT twisted yarn, units each obtained by twisting a plurality of CNT twisted yarns may be further twisted. An example of an electric wire of a CNT twisted yarn in which a plurality of CNT twisted yarns are twisted together and coated with an insulating resin is shown in FIG. 4. In the electric wire of the CNT twisted yarn of FIG. 4, seven CNT twisted yarns 16 are coated with an insulating resin 17.

Examples of the insulating resin used for coating the CNT twisted yarn include polyvinyl chloride, polyethylene, fluorine resin, polyester, and polyurethane.

Electric Wire of CNT Twisted Yarn

The electric wire of the CNT twisted yarn of the present embodiment is obtained by the above-described method for producing a CNT electric wire of the present embodiment, wherein the peak ratio (G/D) of a G band and a D band in the Raman spectrum is 8 or higher, and an electron-attracting group is imparted to the surface thereof. Therefore, as described above, the conductivity is as high as, for example, 750 [S/cm] or higher. To be noted, examples of the electron-attracting group imparted to the surface of the electric wire of the CNT twisted yarn of the present embodiment include electron-attracting groups derived from the oxidizing agents described above.

Meanwhile, the electric wire of the CNT twisted yarn of the present embodiment preferably further includes a dopant in the surface thereof. That is, the peak ratio (G/D) of the G band and the D band in the Raman spectrum of the electric wire of the CNT twisted yarn is 8 or higher, which indicates high crystallinity, and thus the electric wire of the CNT twisted yarn has high carrier mobility. In addition, the electric wire of the CNT twisted yarn includes the dopant in the surface thereof, and thus has high carrier density. That is, since the conductivity is proportional to the product of the carrier mobility and the carrier density as described above and the electric wire of the CNT twisted yarn of the present embodiment has high carrier mobility and high carrier density, the product of these two is large and the conductivity becomes even higher.

Hereinafter, the present invention will be described in more detail with reference to examples and comparative examples, but the present invention is not limited to these examples.

### Example 1

Preparation of CNT Twisted Yarn <Step A>

A CNT twisted yarn was prepared from a multi-walled carbon nanotube forest (vertically oriented CNT sheet material manufactured by Hitachi Zosen Corporation) by a dry spinning method (see FIG. 1).

Graphitization Treatment <Step B>

The CNT twisted yarn that was prepared was placed in a high temperature furnace and subjected to a graphitization treatment by heating under the condition of 2800° C. for 2 hours in an argon gas atmosphere.

Immersion in Oxidizing Agent Solution Etc. <Step C and Step D>

The graphitized CNT twisted yarn was immersed in an aqueous solution of hydrogen peroxide for 72 hours to impart an oxygen-containing functional group (step C). Thereafter, the CNT twisted yarn was immersed in hydrochloric acid for 24 hours to remove residual metal catalyst and the like. After that, the CNT twisted yarn was immersed in sulfuric acid for 24 hours to impart an electron-attracting group (step D).

The CNT twisted yarn of Example 1 was obtained as described above.

Measurement of Conductivity

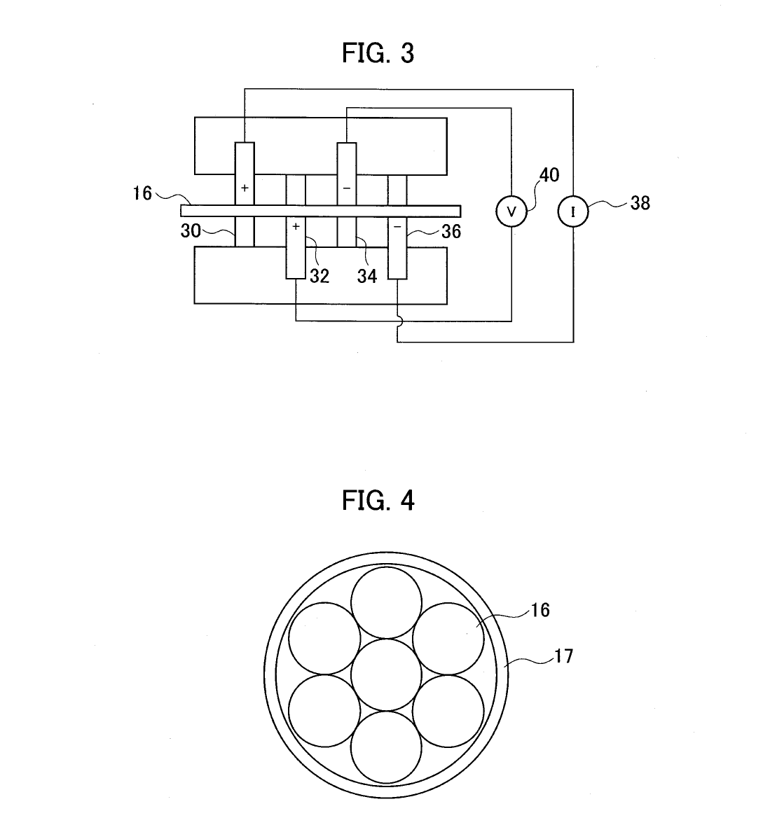

The resistance of the obtained CNT twisted yarn was measured by a four-terminal method. More specifically, as shown in FIG. 3, the CNT twisted yarn 16 is brought into contact with four copper plate terminals 30, 32, 34, and 36, and the voltage between the two copper plate terminals 32 and 34 at the center connected to a voltmeter 40 was measured while current was flowing through the copper plate terminals 30, 36 at both ends connected to an ammeter 38. From the current value and the voltage drop value resulting from the resistance of the CNT twisted yarn 16 at this time, the resistance R which is the inclination thereof was measured. The length L of the sample was the distance between the two copper plate terminals 32 and 34 in the center, and this distance was measured with a ruler. Further, the outer diameter of the sample was measured with a digital microscope, and the sectional area S of the sample was calculated from the outer diameter and the pi.

The conductivity was calculated by substituting the resistance R, the length L, and the cross-sectional area S obtained in the above manner into the following formula (1), and the conductivity was 763 [S/cm].

σ=L/RA (1)

(R represents the resistance, L represents the length of the sample, and A represents the sectional area of the sample.)

### Example 2

An electric wire of a CNT twisted yarn was prepared in the same manner as in Example 1 except that iodine doping was performed (step E) by holding the CNT twisted yarn in iodine vapor for 12 hours after immersing the CNT twisted yarn in sulfuric acid, and the conductivity was measured. The conductivity was 930 [S/cm].

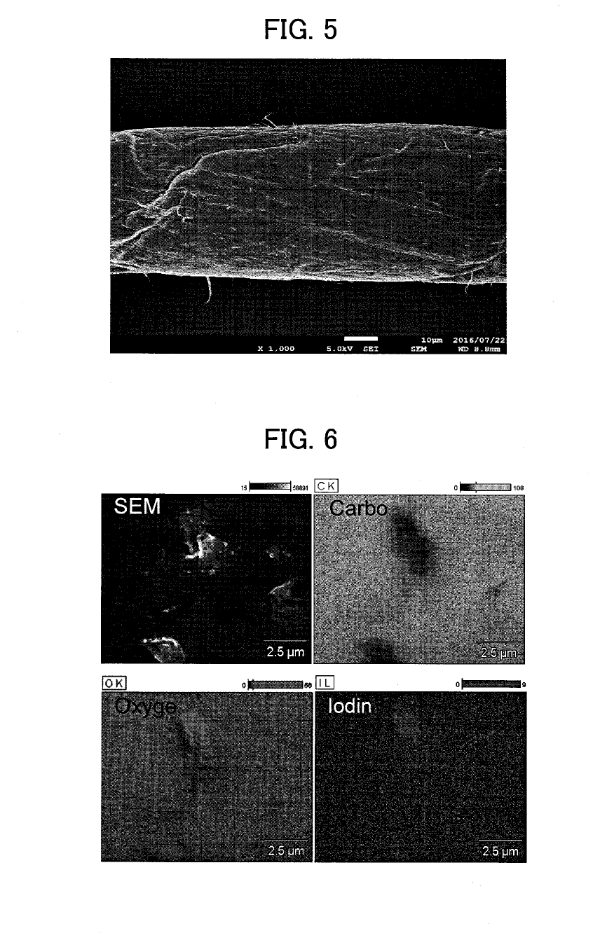

An electron micrograph of the CNT twisted yarn prepared as described above is shown in FIG. 5. From FIG. 5, it can be seen that the diameter was 60 μm and the twist pitch was 0.5 mm from the diameter and the twist angle. FIG. 6 shows element mapping obtained by analyzing the composition of a part of the surface of the CNT twisted yarn by EDS. From FIG. 6, it can be recognized that iodine attaches more to a portion containing more oxygen component derived from the oxygen-containing functional group.

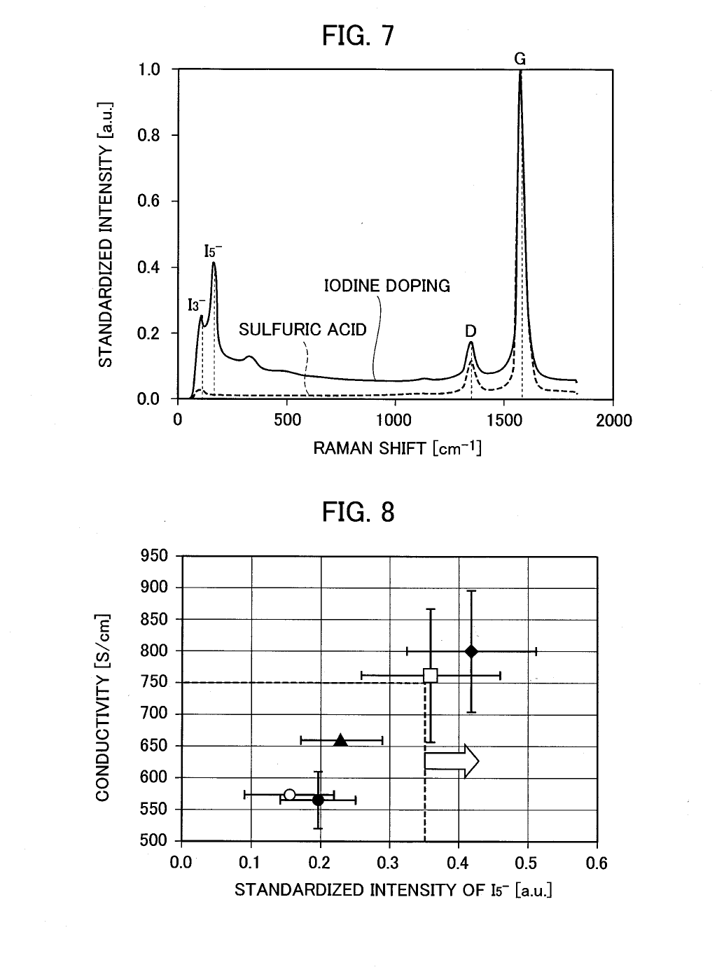

In addition, FIG. 7 shows the result of Raman spectrum analysis of iodine attached as a dopant. Here, the intensity ratio of an I₅⁻ peak to a G peak represents the amount of attached iodine. The relationship between the peak intensity ratio of I₅⁻ and the conductivity is shown in FIG. 8. From FIG. 8, it can be recognized that the conductivity becomes 750 [S/cm] or higher when the peak intensity ratio of I₅⁻ is 0.35 or higher.

### Comparative Example 1

A CNT twisted yarn was obtained in accordance with Example 1 of JP 4577385 described above. In addition, the conductivity was measured in the same manner as in Example 1 described in the present specification, and the conductivity was 15 [S/cm].

### Comparative Example 2

A CNT twisted yarn was obtained in accordance with Example 1 of JP 2011-26192 A mentioned above. In addition, the conductivity was measured in the same manner as in Example 1 described in the present specification, and the conductivity was 524 [S/cm].

### Comparative Example 3

A CNT twisted yarn was obtained by performing spinning while ethanol was sprayed in accordance with Example 1 of JP 2011-207646 A described above. After the spinning, the treatment of Examples 1 and 2 was not performed. In addition, the conductivity was measured in the same manner as in Example 1 described in the present specification, and the conductivity was 125 [S/cm].

Comparison between the examples and comparative examples is described above is shown in Table 1 below.

TABLE 1

| | | Step C | Step D | | |
|---|---|---|---|---|---|
| | Step B | Immersion in | Immersion | Step E | |
| | Graphitization | aqueous solution | in sulfuric | Iodine | Conductivity |
| | treatment | of hydrogen peroxide | acid | doping | [S/cm] |
| Example 1 | Yes | Yes | Yes | No | 763 |
| Example 2 | Yes | Yes | Yes | Yes | 930 |
| Comparative | No | No | No | No | 15 |
| Example 1 | | | | | |
| Comparative | No | No | No | No | 524 |
| Example 2 | | | | | |
| Comparative | No | No | No | No | 125 |
| Example 3 | | | | | |

As shown in Table 1, high conductivity was obtained in Examples 1 and 2, and in particular, higher conductivity than in Example 1 was obtained in Example 2 because iodine doping (step E) was performed. In contrast, in each of Comparative Examples 1 to 3, the conductivity was low.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

### DESCRIPTION OF THE REFERENCE SIGNS

12 CNT FOREST
14 CNT SHEET
16 CNT TWISTED YARN
18 MOTOR
20 CHUCK

1. A method for producing an electric wire of a carbon nanotube twisted yarn, the method comprising:
obtaining a carbon nanotube twisted yarn by a dry spinning method;
subjecting the carbon nanotube twisted yarn to a graphitization treatment;
imparting an oxygen-containing functional group to the graphitized carbon nanotube twisted yarn; and
imparting an electron-attracting group having a stronger electron-attracting property than the oxygen-containing functional group to the carbon nanotube twisted yarn to which the oxygen-containing functional group has been imparted.

2. The method for producing an electric wire of a carbon nanotube twisted yarn according to claim 1, the method further comprising doping the carbon nanotube twisted yarn to which the electron-attracting group has been imparted with one or a plurality of dopants.

3. The method for producing an electric wire of a carbon nanotube twisted yarn according to claim 2, wherein the one or plurality of dopants are at least one selected from a group consisting of halogens, halogen compounds, alkali metals, group 2 elements, acids, and electron-accepting organic compounds.

4. An electric wire of a carbon nanotube twisted yarn comprising a carbon nanotube twisted yarn coated with an insulating resin,
wherein a peak ratio (G/D) of a G band and a D band in a Raman spectrum of the carbon nanotube twisted yarn is 8 or larger, and an electron-attracting group is imparted to a surface of the carbon nanotube twisted yarn.

5. The electric wire of a carbon nanotube twisted yarn according to claim 4, the electric wire further comprising a dopant in a surface thereof.
